(19) United States
(12) Patent Application Publication
(10) Pub. No.: US 2025/0120425 A1
(43) Pub. Date: Apr. 17, 2025

(54) Combinations of Ketogenic Supplements for Rapid and Sustained Blood Ketone Levels in Dieters and Patients

(71) Applicant: Stephen Michael Zarpas, Springfiled, VA (US)

(72) Inventor: Stephen Michael Zarpas, Springfiled, VA (US)

(21) Appl. No.: 17/238,949

(22) Filed: Apr. 23, 2021

(51) Int. Cl. A23L 33/10; A23L 2/52

(52) U.S. Cl. CPC A23L 33/10; A23L 2/52

(57) ABSTRACT

Beta-hydroxybutyrate (BHB) mineral salts and/or beta-hydroxybutyrate (βHB) free acid in combination with 1,3-butanediol (1,3-BD) were used to induce ketosis, achieving blood ketone levels of (2-7 mmol/L), with or without dietary restriction. A combination of the ketogenic compounds, βHB acid and/or βHB salt in together with 1,3BD was more than additive. What has been unknown until now, and what was unexpected is that the specific combination of the partially buffered βHB free acid, (created as a mixture of βHB free acid and βHB salt), together with 1,3-BD in a particular combination is far more than additive. When used together this mixture raises serum levels far higher, up to 70% higher, than would be expected by using 1,3BD together with βHB salt and/or BHB acid. The synergistic combination is 5 times more powerful at raising serum βHB than the enantiomerically pure acid or salt alone and 1.23 times more powerful than the corresponding enantiomerically pure ester compounded from βHB and 1,3-BD. Given the far higher potency, it is now possible to deliver a suitably buffered formulation orally or intravenously in order to achieve a variety of therapeutic benefits without exceeding unsafe salt loads which have in the past, prevented the widespread use of ketone salt and acid. The concurrent co-administration of these compounds is useful to improve metabolic health, cognitive performance, physical performance, enhance disease prevention, mitigate the damage of Ischemia Reperfusion Injury and provide a fuel substrate that is not affected by glucose impairment associated with neurodegenerative diseases. Elevated serum ketones have demonstrated to improve the cognitive function in persons suffering from neurodegenerative diseases such as Alzheimer's and Parkinson's Diseases by providing fuel starved neurons a direct source of fuel, that unlike glucose, is not effected by the glucose and pyruvate dehydrogenase impairments described extensively in the brains of patients suffering from neurodegenerative diseases. This invention results in rapid keto adaptation, which is useful for the avoidance of glucose withdrawal symptoms or “keto flu” commonly experienced by individuals initiating a ketogenic diet. It also minimizes the loss of lean body mass during dietary restriction and does not adversely impact lipid profiles.

The classifications are assigned by a computer and are not a legal conclusion. Google has not performed a legal analysis and makes no representation as to the accuracy of the classifications listed.

### A Human Necessities

A61 MEDICAL OR VETERINARY SCIENCE; HYGIENE
A61K PREPARATIONS FOR MEDICAL, DENTAL, OR TOILET PURPOSES
A61K31/00 Medicinal preparations containing organic active ingredients
A61K31/21 Esters, e.g. nitroglycerine, selenocyanates
A61K31/215 Esters, e.g. nitroglycerine, selenocyanates of carboxylic acids
A61K31/22 Esters, e.g. nitroglycerine, selenocyanates of carboxylic acids of acyclicacids, e.g. pravastatin
A61K31/23 Esters, e.g. nitroglycerine, selenocyanates of carboxylic acids of acyclicacids, e.g. pravastatin of acids having a carboxyl group bound to a chain of seven or more carbon atoms

### A Human Necessities

A23 FOODS OR FOODSTUFFS; THEIR TREATMENT, NOT COVERED BY OTHER CLASSES
A23L FOODS, FOODSTUFFS, OR NON-ALCOHOLIC BEVERAGES, NOT COVERED BY SUBCLASSES A23B-A23J; THEIR PREPARATION OR TREATMENT, e.g.
COOKING, MODIFICATION OF NUTRITIVE QUALITIES, PHYSICAL TREATMENT; PRESERVATION OF FOODS OR FOODSTUFFS, IN GENERAL
A23L2/00 Non-alcoholic beverages; Dry compositions or concentrates therefor;
   Their preparation
A23L2/52 Adding ingredients A HUMAN NECESSITIES
A61 MEDICAL OR VETERINARY SCIENCE; HYGIENE
A61K PREPARATIONS FOR MEDICAL, DENTAL, OR TOILET PURPOSES
A61K31/00 Medicinal preparations containing organic active ingredients
A61K31/045 Hydroxy compounds, e.g. alcohols; Salts thereof, e.g. alcoholates
A61K31/047 Hydroxy compounds, e.g. alcohols; Salts thereof, e.g. alcoholates having two or more hydroxy groups, e.g. sorbitol

### A Human Necessities

A61 MEDICAL OR VETERINARY SCIENCE; HYGIENE
A61K PREPARATIONS FOR MEDICAL, DENTAL, OR TOILET PURPOSES
A61K31/00 Medicinal preparations containing organic active ingredients
A61K31/185 Acids; Anhydrides, halides or salts thereof, e.g. sulfur acids, imidic, hydrazonic, hydroximic acids
A61K31/19 Carboxylic acids, e.g. valproic acid

### A Human Necessities

A61 MEDICAL OR VETERINARY SCIENCE; HYGIENE
A61K PREPARATIONS FOR MEDICAL, DENTAL, OR TOILET PURPOSES
A61K31/00 Medicinal preparations containing organic active ingredients
A61K31/185 Acids; Anhydrides, halides or salts thereof, e.g. sulfur acids, imidic, hydrazonic, hydroximic acids
A61K31/19 Carboxylic acids, e.g. valproic acid
A61K31/20 Carboxylic acids, e.g. valproic acid having a carboxyl group bound to a chain of seven or more carbon atoms, e.g. stearic, palmitic, arachidic acids

### A Human Necessities

A61 MEDICAL OR VETERINARY SCIENCE; HYGIENE
A61K PREPARATIONS FOR MEDICAL, DENTAL, OR TOILET PURPOSES
A61K31/00 Medicinal preparations containing organic active ingredients
A61K31/21 Esters, e.g. nitroglycerine, selenocyanates
A61K31/215 Esters, e.g. nitroglycerine, selenocyanates of carboxylic acids
A61K31/22 Esters, e.g. nitroglycerine, selenocyanates of carboxylic acids of acyclicacids, e.g. pravastatin

### A Human Necessities

A23 FOODS OR FOODSTUFFS; THEIR TREATMENT, NOT COVERED BY OTHER CLASSES
A23 V INDEXING SCHEME RELATING TO FOODS, FOODSTUFFS OR NON-ALCOHOLIC BEVERAGES
A23 V2002/00 Food compositions, function of food ingredients or processes for food or food stuffs
WO2014153416A1
WIPO (PCT)

### Other Languages

French Inventor
Stephen M Zarpas
Worldwide applications 2014 PE
Application number: PE2015002047A Filing date: 2014 Mar. 19
Legal status:
WO
Application number: PCT/US2014/031237 Filing date: 2014 Mar. 19
Legal status: application Filing
Application number: MX2015013312A Filing date: 2014 Mar. 19
Legal status:
RU
Application number: RU2015136190A Filing date: 2014 Mar. 19
Legal status:
JP
Application number: JP2016504350A Filing date: 2014 Mar. 19
Legal status: ActiveEP
Application number: EP14770025.6A Filing date: 2014 Mar. 19
Legal status: PendingCA
Application number: CA2902603A Filing date: 2014 Mar. 19
Legal status: PendingRU
Application number: RU2018120938A Filing date: 2014 Mar. 19
Legal status:
KR
Application number: KR1020157025528A Filing date: 2014 Mar. 19
Legal status:
SG
Application number: SG10201808690PA Filing date: 2014 Mar. 19
Legal status:
NZ
Application number: NZ711433A Filing date: 2014 Mar. 19
Legal status:
CN
Application number: CN201480016818.0A Filing date: 2014 Mar. 19
Legal status: Search and Examination BR
Application number: BR112015024186A Filing date: 2014 Mar. 19
Legal status: Search and Examination AU
Application number: AU2014236004A Filing date: 2014 Mar. 19
Legal status: ActiveSG
Application number: SG11201506780RA Filing date: 2014 Mar. 19
Legal status:
US
Application number: U.S. Ser. No. 14/455,385 Filing date: 2014 Aug. 8
Legal status: Active 2015 ZA
Application number: ZA2015/06387A Filing date: 2015 Sep. 1
Legal status:
PH
Application number: PH12015501966A Filing date: 2015 Sep. 4
Legal status:
IL
Application number: IL241316A Filing date: 2015 Sep. 8
Legal status: IP Right GrantCL
Application number: CL2015002802A Filing date: 2015 Sep. 17
Legal status:
US
Application number: U.S. Ser. No. 14/860,092 Filing date: 2015 Sep. 21
Legal status: ActiveCR
Application number: CR20150579A Filing date: 2015 Oct. 19
Legal status:
2016 HK
Application number: HK16104766.6A Filing date: 2016 Apr. 26
Legal status:
2017 US
Application number: U.S. Ser. No. 15/610,668 Filing date: 2017 Jun. 1
Legal status: Pending 2018 CL
Application number: CL2018000983A Filing date: 2018 Apr. 17
Legal status: IL
Application number: IL259502A Filing date: 2018 May 21
Legal status:
JP
Application number: JP2018227049A Filing date: 2018 Dec. 4
Legal status: Pending 2019 AU
Application number: AU2019200511A Filing date: 2019 Jan. 25
Legal status: Pending

### Application PCT/US2014/031237 Events

A timeline of key events for this patent application, including priority claims, publications, legal status, reassignments, and litigation.

Google has not performed a legal analysis and makes no representation as to the accuracy or completeness of the events listed.
2013 Mar. 19
Priority to US201361803203P 2013 Mar. 19
Priority to U.S. 61/803,203 2014 Jan. 13
Priority to US201461926664P 2014 Jan. 13
Priority to U.S. 61/926,664 2014 Mar. 19
Application filed by University Of South Florida 2014 Sep. 25
Publication of WO2014153416A1 2018 Feb. 21
First worldwide family litigation filed
“Global patent litigation dataset” by Darts-ip is licensed under a Creative Commons Attribution 4.0 International License.

### Info

Patent citations (23)
Non-patent citations (1)
Cited by (18) Legal events Similar documents
Priority and Related Applications
External links
   Espacenet Global Dossier Patent Scope
   Discuss

### FIELD OF INVENTION

This invention relates to the use of ketogenic precursors to quickly and safely produce elevated and sustained levels of ketone bodies in the blood without overloading the body with cations of salt or produce acidosis as is common in the use of straight mineral salts of BHB or straight beta-hydroxybutyric acid and methods for assisting the body's transition into nutritional ketosis. Specifically, and in particular the use of a combination of non-racemic (D)-1,3-butanediol (1,3BD) with non-racemic (D) mineral salts and the (D) enantiomer of the free acid of beta-hydroxybutyrate (βHB) is presented to provide an easy and accelerated method for inducing and sustaining high levels of nutritional ketosis without exceeding safe levels of serum cations.

### BACKGROUND OF THE INVENTION

Nutritional, or therapeutic, ketosis is the physiological state of elevated blood ketone body levels (typically above 0.5 mmol/L) resulting from ketogenic diets, calorie restriction, therapeutic fasting and/or supplementation with ketogenic precursors.

Ketone bodies represent alternative energy substrates for both peripheral tissues and the central nervous system. The two most abundant and physiologically significant ketone bodies are acetoacetate and β-hydroxybutyrate (βHB), while the third ketone body, acetone, is produced as a byproduct that the lungs breathe off. The body produces ketone bodies during nutritional or therapeutic ketosis in the range of 2-16 mmol/L. The metabolism of ketone bodies is associated with anticonvulsant effects, enhanced brain metabolism, neuroprotective, muscle sparing properties and improvement in cognitive and physical performance. Science-based improvements in efficiency of cellular metabolism, managed through ketone supplementation, could have beneficial impacts on physical, cognitive health, psychological health, warfighter resilience and a long-term impact on health with respect to the common avoidable diseases such as obesity, neurodegenerative diseases, diabetes and cancer.

Under normal conditions of the standard American diet, the brain is exclusively dependent upon the metabolism of glucose to supply its metabolic energy. Though the brain is only 2% of bodyweight, it represents 25% of total glucose consumption and deprivation, glucose availability decreases causing a metabolic shift towards fatty acid beta-oxidation and the production of ketone bodies for energy homeostasis.

Dietary carbohydrates (carbs) include simple sugars, such as table sugar (sucrose) and complex carbohydrates (starch) found in foods like potatoes and pasta. Carbohydrate and sugar consumption have dramatically increased in the last two centuries in Western societies. When sugars and carbohydrates are consumed by humans, the pancreas secretes insulin, a hormone used to convert the sugars and carbohydrates into glucose. The glucose is then used by the body as a fuel source, in most Western diets, glucose is the body's primary fuel source.

In periods of fasting, extreme exercise, and/or low carbohydrate consumption, glucose stores in the body are rapidly used and can become quickly depleted. Failure to replenish glucose stores as they become depleted causes the body to turn to an alternative method to generate energy by creating ketone bodies. Ketone bodies can be used by every cell of the body except in some liver cells as a replacement fuel to satisfy the body's energy needs, including the needs of the brain. During a prolonged fast, for example, blood ketone levels will increase to as high as 2 or 3 mmol/L. It is conventionally understood and agreed that when blood ketones rise above 0.5 mmol/L, the heart, brain and peripheral tissues are using ketone bodies (beta hydroxybutyrate and acetoacetate) as the primary fuel source. This condition is referred to as ketosis, or “nutritional ketosis.” This is distinguished from, and should not be confused with, diabetic or alcoholic ketoacidosis, which is the runaway accumulation of ketone bodies and associated drop in blood pH. Diabetic ketoacidosis is associated with the absence of insulin as occurs in those suffering from type 1 diabetes. Ketoacidosis typically results in blood ketone levels in excess of 25 mmol/L in combination with metabolic derangement and electrolyte imbalance.

When in ketosis, the body essentially burns fat for fuel. This is accomplished because fat stores in the body are utilized to create the water-soluble ketone bodies beta-hydroxybutyrate (βHB) and acetoacetate (also known as acetyiacetonate). These ketone bodies are then used by the body as its primary energy source. The body enters a state of ketosis when it has no dietary source of glucose or sugar and its stores of glycogen have been depleted. This typically occurs during fasting, exercise, and/or pursuing a carbohydrate restricted ketogenic diet. Upon transitioning into ketosis, the body begins cleaving fats into fatty acids and glycerol and transforms the fatty acids into acetyl COA molecules which are then eventually transformed into ketone bodies in the liver. In other words, during ketogenic metabolism in the liver, the body uses dietary and bodily fats as its primary energy source. Consequently, once in ketosis, one can easily induce loss of body fat by reducing dietary fat intake and adjusting carbohydrate intake low enough to sustain ketosis.

### Effects of Ketosis on Cognitive and Physical Performance

Performance studies in rats, mice, human subjects and elite athletes have shown improved motor function, endurance and cognitive function with ketone supplementation. Resilience of cardiopulmonary and neurological function under extreme environments of oxidative stress (hyperoxia) has been achieved in rats given ketone supplementation Many people on a ketogenic diet report greater mental clarity, an enhanced ability to multi-task, and a more favorable and balanced mood. Anecdotal reports have shown significant improvement in cognition in persons suffering from dementia, Alzheimer's and Parkinson's diseases.

Other advantages to the ketogenic diet including anti-aging and mood stabilizing effects. Recent animal studies have demonstrated superior performance with respect to endurance time, volume of oxygen consumed, heart rate, blood lactate levels and power output when blood ketone levels are elevated.

### Therapeutic Ketosis to Ameliorate Disease

The ketogenic diet has been established to be efficacious in treating drug-resistant seizure disorders. This therapeutic method is well established in children and adults. The ketogenic diet has been used to treat pediatric intractable seizures since the 1920s. The diet is currently being investigated as treatment for a broad list of disease states from cardiovascular health and type II diabetes to cancer and neurological disorders such as amyotrophic lateral sclerosis (ALS), Alzheimer's disease, Parkinson's disease, ischemic stroke, ischemic cardiomyopathy and traumatic brain injury. More recently, the combination of a ketogenic diet and co-administration of the glutamine antagonist, DON, have shown to shrink glioblastoma tumors. Additionally, some studies have suggested that cancer cells cannot metabolize ketones and therefore further investigation of therapeutic ketosis for cancer is underway. The metabolic adaptations associated with a ketogenic diet improve mitochondrial function, decrease reactive oxygen species (ROS) production, reduce inflammation and increase the activity of neurotrophic factors. Thus, using ketones to treat traumatic brain injury has also been suggested.

As disclosed in studies relating to the effects of ketosis on cognition and performance, medium chain triglyceride diets have been used to alleviate symptoms of Alzheimer's disease and dementias, as seen in Henderson, et al. (U.S. Pat. No. 8,428,468). As Alzheimer's disease was attributed to decreased neuronal metabolism and reduced glucose availability to neurons, it was suggested that elevating ketone bodies in these patients provides an alternative fuel source for the neurons. Lipases hydrolyze the medium chain triglycerides to medium chain fatty acids in the duodenum, permitting uptake of the medium chain fatty acids that are subsequently oxidized by the liver to form ketone bodies. Alternatively, Henderson, et al., suggested intravenous administration of medium chain triglycerides, medium chain fatty acids, or ketone bodies. The increase in blood ketone levels provides neurons with a supplemental fuel where glucose is not accessible to the neuron, such as in Alzheimer's disease.

Henderson (U.S. Pat. No. 8,124,589) used oral compositions of medium chain triglycerides to treat age-associated memory impairment, thereby increasing ketone body levels in the blood. Veech (U.S. Pat. No. 6,323,237) also disclosed compositions containing ketone bodies for treating neuronal damage, and also found the compositions useful for increasing cardiac efficiency, providing energy to diabetics and patients suffering from insulin resistance. The compositions include esters and polymers. As amyloid proteins responsible for Alzheimer's disease block pyruvate dehydrogenase, which is part of glucose metabolism, ketone bodies such as D-R-3-hydroxybutyrate, acetoacetate, and derivatives of these compounds are useful fuel sources.

Ketones have been shown to decrease glucose levels and increase the sensitivity to active transporters for glucose and ascorbic acid. By combining ketones and ketone precursors together with ascorbic acid (AA), AA is more efficiently absorbed by the body and transported into cells and in particular immune system cells. Phagocytes in particular use AA which is converted into ROS to destroy bacterial, fungal and viral infections. An orally delivered form of AA with greater cellular absorption would reduce the necessity of IV transfusions of AA in cases of viral infection.

### Ketogenic Diets on Weight Loss

A ketogenic diet is one that is high in dietary fat and low in carbohydrates with moderate levels of protein (approximately 1-2 g/kg). The classical ketogenic diet consists of a strict regimen of 4 parts fat to 1-part protein with less than 25-50 g of carbohydrates per day. It has been suggested that the ideal macronutrient ratio to maintain a ketogenic diet is 65-85 percent of calories from fats, 10-20 percent of calories from proteins, and 5 percent of calories from carbohydrates.

A significant advantage of pursuing weight loss through a ketogenic diet is that a ketogenic diet may result in loss of fat stores while maintaining and protecting muscle mass. A 2017 study has shown that a βHB ester upregulates the mTOR complex increasing muscle protein synthesis. Some studies have suggested that the muscle sparing properties of a ketogenic diet result in improvement in physical performance. Athletes who maintain nutritional ketosis maintain lower insulin levels and can better utilize fatty acids and ketones for fuel, effectively sparing blood glucose, which optimizes and prolongs physical and mental performance. This state is referred to as being “keto adapted,” Keto adaptation occurs when the body adjusts to ketosis by building up the necessary fat-burning enzymes, hormone levels are changed to accommodate ketosis, glycogen stored in muscles and liver is reduced, and the body is carrying less water. Individuals on the standard American diet can expect to get peak fat oxidation while exercising from between 60 to 85 percent of their maximum oxygen consumption (VO2max); higher exertion levels will then deplete glycogen stores. Keto-adapted Individuals draw proportionally more substrate from fats and ketones (sparing glycogen) and can shift the peak to much higher VCh levels and thus sustain effort for an extended duration. Transitioning to a keto-adapted state blood ketones >0.5 mmol/L) typically requires 1 to 2 weeks with severe restriction of carbohydrates (<25 g/day) and moderate protein restriction (1 g/kg/day) with the balance of macronutrient from fat. A sustained physiological decrease in glucose and insulin are required for sustained hepatic ketogenesis, which is very difficult for most humans.

Viahakos (U.S. Pat. No. 6,613,356) provides a weight-loss composition using n-butyrateions from potassium butyrate or related compounds. Butyric acid stimulates receptors in the stomach that the stomach is full and food is stagnant in the stomach. Thus, consuming butyric acid precursors prior to eating reduces food consumption. Testing showed the compositions improved a patient's ability to withstand rigorous exercise, improved hypercholesterolemia and hypertriglyceridemia, and reduced fatigue.

Another advantage to pursuing weight loss through a ketogenic diet is that being in ketosis reduces hunger. Indeed, hunger is the major barrier that is often cited for the inability to maintain a traditional calorie restricted diet.

Despite the many health advantages to pursuing a ketogenic diet and maintaining a state of nutritional ketosis, there remain significant barriers to pursuing and maintaining a ketogenic lifestyle. One of these barriers is the difficulty of transitioning into a ketogenic state. The fastest way to deplete glucose stores in the body is through fasting combined with exercise. This is physically and emotionally demanding and is an extreme challenge even for the most motivated and disciplined. Individual reports recounting the difficulties of entering ketosis when using a dietary approach have been widely published. In a typical example, an individual reported no effects on blood ketone levels even after four days of strict adherence to a ketogenic diet (80% fat/20% protein; 90% of maintenance calories; less than 15 grams of carbs in any given day). Another common experience is extreme hunger during a week-long ketogenic diet without experiencing satiety during meals unless 100-200 g of carbohydrates per day were consumed.

The ability for much larger numbers of people to utilize the significant advantages of ketosis are severely restricted by the ability to get into ketosis. This invention opens up the potential for large numbers of people to quickly and easily get into ketosis and be able to sustain a ketogenic lifestyle without the physiological and emotional challenges brought on through the process of getting into and sustaining ketosis. At the same time, ketone salts and in particular synthetic, racemic ketone salts pose far too high a salt load to safely achieve therapeutic serum levels of 1.0 mmol-2.0 mmol βHB. Additionally, the transition into ketosis causes lethargy and light-headedness in many, resulting in an uncomfortable physiological and mental state commonly referred to as the “low carb flu,” or “keto-flu.” Some suggest that these transitory symptoms may last as long as two to three weeks, if any carbohydrates over the restrictive amount are consumed, there is an immediate shift back to glucose utilization and the transition into ketosis must begin anew. The symptoms associated with transitioning from a sugar and carbohydrate-rich diet into a state of ketosis will vary according to the physiology of the particular subject. Thus, some people may experience minimal discomfort as they transition into ketosis. On the other hand, however, some people may experience these symptoms to such a degree that the symptoms present what may seem to be an insurmountable impediment to getting into ketosis and taking advantage of the positive health effects that can be achieved by living in a state of ketosis. The vast majority of those who attempt to induce ketosis through some combination of diet, fasting, and exercise will experience some of these symptoms.

Because the presence of blood ketones can be easily measured by a urine or blood test using one of many ketone test strips available on the commercial market, those desirous of pursuing a state of ketosis can easily measure their progress. Just as those on a traditional diet can weigh themselves and gain positive feedback by measuring weight loss, those pursuing a state of ketosis can also be encouraged by measuring their blood ketone levels. However, when transitioning into ketosis, it may take from several days to two weeks or longer for any measurable increase in blood ketone levels to manifest through a urine test. This lack of measurable progress can be yet another impediment to pursuing a state of ketosis.

Following a ketogenic diet requires eliminating substantially all sugars and carbohydrates including fruit from the diet. To someone who derives pleasure from eating cakes, candies, breads, grains, fruits and other non-ketogenic foods, the necessary modification to their diet will pose an additional often insurmountable hurdle to pursuing long-term nutritional ketosis. With proper education and advance planning, implementing a ketogenic meal plan at home is manageable for many. However, because restaurant dining is part of the social fabric for many people, maintaining a ketogenic diet in such social settings requires further education and may place one in awkward social settings, providing yet another impediment to widespread implementation of a ketogenic diet. Additionally, in today's society, many people frequently travel. For a frequent traveler to maintain a ketogenic diet will typically require that they either carry appropriate food with them or attempt to maintain the ketogenic diet in settings where few, if any, ketogenic foods may be available.

It has been suggested that transitioning into ketosis may be aided by taking ketogenic medical foods or exogenous supplemental ketones. However, ketogenic fats like medium chain triglyceride oil (MCT oil) are generally not well tolerated by the gastrointestinal system in quantities necessary to aid in inducing ketosis. Additionally, oral administration of βHB and acetoacetate in their free acid form is expensive and ineffective at producing sustained ketosis. One idea has been to buffer the free acid form of βHB with sodium salts, but this causes a potentially harmful sodium overload and mineral imbalance to achieve therapeutic levels of ketosis and is largely ineffective at preventing seizures in animal models. Ketone salts with a balance of minerals can prevent the sodium overload, but these balanced ketone mineral salts also cause an overload of cations before reaching therapeutic levels of βHB between 1.0 mmol-2.0 mmol. Persons with high blood pressure cannot achieve therapeutic levels of ketosis depending on ketone salts especially with widely available racemic salts that contain only 50% of the bioactive (D) enantiomer.

Concerns have been raised about ketogenic diets increasing total cholesterol and triglycerides while decreasing high density lipoprotein (HDL) levels. This lipid profile is a key predictor of heart health: atherosclerotic lesions, fatty streaks and fibrous plaques in the aorta and coronary arteries. This is more limiting during adult treatment with the ketogenic diet. Based on the broad therapeutic potential for pursuing and sustaining a ketogenic lifestyle, the need to develop an oral ketone supplement that could safely elevate blood ketone levels to therapeutic ranges of nutritional ketosis without severe dietary restriction and the associated side effects is greater than ever.

As such, what is needed is a composition and corresponding treatment and maintenance method that permits the establishment of ketosis in a patient quickly, safely, and the maintenance of ketosis with little to no perceived impact on the patient's physiology or mental comfort.

### SUMMARY OF THE INVENTION

A ketogenic diet is effective at raising blood ketone levels and has potential broad applications, but achieving the advantages of those applications requires strict compliance which has historically shown to be unsustainable for many in the long term. The present invention provides a strategy to elevate and sustain blood ketone body levels through the administration of novel combinations of ketogenic supplements and causes a rapid and sustained elevation of blood ketones with a single oral administration. The invention exploits the metabolic and physiological advantages of sustained ketosis (e.g., keto-adaptation) which utilizes ketones as an alternative fuel to improve metabolic health, cognitive performance, physical performance and enhance disease prevention.

As such, a composition of ketone precursors is disclosed which comprises at least one part 1,3-butanediol and one part a β˜hydroxybutyrate ketone source or precursor. There are numerous sources of ketones and ketogenic precursors. Nonlimiting examples of the beta-hydroxybutyrate compound include beta-hydroxybutyrate salts such as sodium beta-hydroxybutyrate and arginine beta-hydroxybutyrate, potassium beta-hydroxybutyrate, calcium beta-hydroxybutyrate, magnesium beta-hydroxybutyrate, lithium beta-hydroxybutyrate, lysine beta-hydroxybutyrate, histidine beta-hydroxybutyrate, ornithine beta-hydroxybutyrate, creatine beta-hydroxybutyrate, agmatine beta-hydroxybutyrate, citrulline beta-hydroxybutyrate, beta-hydroxy butyrate sodium salt, beta-hydroxy butyrate potassium salt, beta-hydroxy butyrate calcium salt, beta-hydroxy butyrate magnesium salt, or a combination of salts. Nonlimiting examples of combinations of beta-hydroxybutyrate salts include sodium beta-hydroxybutyrate and arginine beta-hydroxybutyrate, or beta-hydroxybutyrate sodium salt and beta-hydroxy butyrate potassium salt. Other β-hydroxybutyrate ketone sources include, without limiting the scope, ethyl acetoacetate, and ethyl beta-hydroxybutyrate. The compounds are optionally administered between 2 grams and 50 grams, between 5 grams and 30 grams, or between 10 grams and 20 grams. For example, the ketone compounds are optionally administered at 2 grams, 4 grams, 5 grams, 6 grams, 7 grams, 8 grams, 9 grams, 10 grams, 11 grams, 12 grams, 13 grams, 14 grams, 15 grams, 17 grams, 19 grams, 20 grams, 22 grams, 24 grams, 26 grams, 28 grams, 30 grams, 32 grams, 34 grams, 36 grams, 38 grams, 40 grams, 42 grams, 44 grams, 46 grams, 48 grams, or 50 grams.

In some variations of the invention, the beta-hydroxy butyrate compound is histidine beta-hydroxybutyrate, ornithine beta-hydroxybutyrate, creatine beta-hydroxybutyrate, agmatine beta-hydroxybutyrate, or citrulline beta-hydroxybutyrate. The compound is optionally a racemic (DL)-beta hydroxybutyrate or the single isomer R-beta hydroxybutyrate. In some variations the 1,3BD component is the racemic (D/L) 1,3BD or the preferred (D)-1,3BD.

Unexpectedly and not yet understood is the fact that the (D) enantiomer of 1,3BD is more than twice as effective and nearly 3 times as effective at raising serum levels of (D)-beta-hydroxybutyrate.

The same serum raising effects are apparent with the salts and free acid from of βHB, when comparing the racemic (D/L) versions in comparison to the pure or nearly pure (D) forms of the salts and free acid of βHB at raising serum levels of (D)-beta-hydroxybutyrate. One would expect, for instance that, that if 10 grams of (D)-1,3BD could raise serum levels in a 75 kg person to 0.9 mmol, then 20 grams of racemic (D/L)-1,3BD should have the same effect. That is not the case. Actual serum levels in a 75 kg person after taking 20 grams of the racemic (D/L)-1,3BD have been shown to raise serum levels of D-beta-hydroxybutyrate to only 3.0-3.5 mmol.

It is also contemplated that additional ketone precursors or supplements might be used in combination with beta hydroxybutyrate and 1,3BD. These additional ketone precursors or supplements might include acetoacetate, ketone esters, and other compounds that cause a rise in blood ketone levels.

As noted, many individuals, especially females, experience lethargy and light-headedness, referred to by some as the “low carb flu,” caused by glucose withdraw in the brain and to a depletion of minerals, especially sodium and potassium in the plasma when entering ketosis through a ketogenic diet. These symptoms can be attenuated or reversed with the slight supplementation of sodium, potassium, calcium and magnesium by using a combination of βHB mineral salts and βHB free acid together with 1,3BD in order to safely raise serum levels without exceeding safe salt loads while replacing sodium and potassium lost through diuresis. Supplemental administration of minerals prevents potassium depletion via the renal-adrenal aldosterone pathway. As such, the invention optionally uses mineral salts of beta-hydroxybutyrate (βHB). Mineral salts of βHB are described above and include, without limiting the scope of the invention, potassium βHB, sodium βHB, calcium βHB, magnesium βHB, lithium BHB and any other feasible non-toxic mineral salts of βHB. Organic salts of BHB include, without limiting the scope of the invention, salts of organic bases such as arginine βHB, lysine βHB, histidine BHB, ornithine βHB, creatine βHB, agmatine βHB, and citrulline βHB. The salts may contain the racemic DL-beta hydroxybutyrate or the single enantiomer (D)-beta hydroxybutyrate. The 1,3-butanediol may contain the racemic (D/L) 1,3BD or the single enantiomer (D)-1,3BD. As a nonlimiting example, the (D) or (D/L) 1,3BD is administered at 1 gram, 2 grams, 3, grams, 4.5 grams, 5 grams, 6 grams, 7 grams, 8 grams, 9 grams, 10 grams, 1 1 grams, 12 grams, 13 grams, 14 grams, 15 grams, 17 grams, 19 grams, 20 grams, 22 grams, 24 grams, 26 grams, 28 grams, 30 grams, 32 grams, 34 grams, 36 grams, 38 grams 40 grams.

The composition always includes the free acid of βHB in either the non-racemic (D) form or the racemic (D/L) form or a combination thereof. A nonlimiting example is administered at 1 gram, 2 grams, 3, grams, 4.5 grams, 5 grams, 6 grams, 7 grams, 8 grams, 9 grams, 10 grams, 1 1 grams, 12 grams, 13 grams, 14 grams, 15 grams, 17 grams, 19 grams, 20 grams, 22 grams, 24 grams, 26 grams, 28 grams, 30 grams, 32 grams, 34 grams, 36 grams, 38 grams 40 grams.

The composition optionally includes at least one non-toxic mineral salt. Nonlimiting examples include the minerals Na, g, V, K, Cr, Mn, Co, Cu. Zn, As, Mo and Se associated with an ion of chlorine, sulfate, iodine, bromine, or other known ion in the art. Examples Include sodium chloride, zinc sulfide, potassium iodine. More specifically, the mineral salt would include a combination of sodium and potassium βHB in order to buffer the free acid βHB for oral and/or parenteral administration and maintain proper metabolic levels of sodium and potassium that are leached out due to the diuretic effects of βHB.

The ketone precursors are preferably ingested along with nutritional substrates such as free amino acids, amino acid metabolites, vitamins, minerals, electrolytes and metabolic optimizers such as NADH, soluble ubiquinol, tetrahydrobiopeterin, alpha-ketoglutaric acid, carnitine, and/or alpha lipoic acid, nutritional co-factors, calcium beta-methyl-beta-hydroxybutyrate, arginine alpha-ketoglutarate, sodium R-alpha lipoic acid, thiamine, riboflavin, niacin, pyridoxine, ascorbic acid, citric acid, malic acid, sodium benzoate, potassium sorbate, acesulfame K, aspartame, xanthan gum, or a combination thereof. Nonlimiting examples of nutritional co-factors include R-alpha lipoic acid, acetyl-l-carnitine, ketoisocaproate, alpha-ketoglutarate, alpha-hydroxyisocaproate, creatine, branched chain amino acids (leucine, isoleucine, valine), beta-hydroxy-beta methylbutyrate (HMB), B vitamins, vitamin C, soluble ubiquinol, and carnitine that assist in mitochondrial function, in some variations, the supplemental mixture shall provide no more than 720 calories per day.

The compositions are useful for weight loss and treatment of high blood glucose or type II diabetes and can improve the user's general health in a short period of time. In another embodiment, the βHB salt+βHB acid/1,3BD formula is used to facilitate weight loss, as a brain tonic, to enhance athletic performance, to help prevent diseases related to metabolic dysfunction, mitochondrial defect, and insulin resistance, as a myocardial protective and neuro protective formulation to prevent cell death associated with ischemia, as an adjunct to a ketogenic diet, as an anti-aging supplement, and other uses associated with improved metabolic health. A combination (βHB salt+βHB acid)/1,3BD composition is optionally administered in a range of 10:1 to 1:2 mixture to elevate blood ketones to a level that would be considered a state of nutritional ketosis.

Administration can be performed with or without dietary restriction, in some variations, the patient preferably follows a ketogenic diet that restricts intake of carbohydrates and protein during the period of administration of the βHB/1,3BD composition, in specific embodiments, the patient restricts the dietary intake to a ratio of about 65-80% fat, 25-15% protein, and 10-5% carbohydrates. The therapeutic ketosis produced herein provides a rapid and sustained keto-adaptation as a metabolic therapy for a wide range of metabolic disorders, and provides nutritional support for therapeutic fasting, weight loss, and both performance and cognitive enhancement. As such, the composition is optionally administered once per day, twice per day, or three times per day to a subject desiring to promote and/or sustain a state of ketosis. The total volume of the βHB/1,3BD composition is not to exceed 150 grams per day based on the maximum production of βHB free acid of 150 grams per day in an average 75 kg human at the peak of dietary ketosis.

In an embodiment of the invention, the preferred route of administration of the mixture of (βHB salts+βHB acid)/1,3BD is oral. The product may be delivered intravenously when buffered preferably in the pH range of 4 to 8. The product may be delivered as a ready-to-drink liquid, soft gelatin caps, concentrated gels, as the active ingredient in food bars, chews, creamers, shakes or any other dosage form known to those trained in the art. The product is preferably delivered in the form of a ready-to-drink formula consisting of a mixture of sodium and potassium βHB along with βHB free acid and 1,3BD. The drink may be pH adjusted with citric and/or malic acid, and artificial sweetener and flavoring can be added.

Because the supplements and methods of the present invention will raise the level of blood ketones, the subject may enjoy greater flexibility in the diet that must be traditionally be followed to maintain a state of ketosis. Thus, while consistently taking the supplement of the present invention, a subject may be able to enjoy an occasional carbohydrate or sugar “cheat” and not significantly jeopardize their ketogenic state, indeed, because the present invention facilitates the quick and easy transition into ketosis, should one need to depart from a strict ketogenic diet for a day or two, getting back into ketosis can be accomplished quickly and without the difficult symptoms which heretofore impeded the process. The present invention is so powerfully ketogenic that the subject may choose to eat a standard, high carbohydrate, western diet and still easily achieve the 0.5 mmol threshold for ketosis without exceeding safe salt loading. The present invention allows for far higher levels of ketosis in the range of 4-7 mmol without exceeding the safe upper limits for total salt load. There are certain conditions and benefits in achieving higher levels of ketosis. In particular, subjects suffering from ischemia require the delivery of βHB in high concentrations to promote the delivery of the fuel substrate βHB to blood flow restricted ischemic tissue via passive diffusion. 4-7 mmol concentrations cannot be safely achieved with βHB salt acid or 1,3BD alone. The acid is too acidic for oral or parenteral delivery. The salt alone carries too high a salt load and the 1,3BD in high doses produces alcohol intoxication. Elite athletes seeking record breaking performance require serum levels of 4-7 mmol in order that βHB can act as the primary fuel substrate for skeletal and myocardial tissue. Again, those high levels cannot be safely achieved with βHB salts, βHB acid or 1,3BD alone.

Through the consumption of the supplements of the present invention, a measurable increase in blood ketones can often be observed within minutes of taking the supplements with peak serum concentration being achieved between 20 and 60 minutes on an empty stomach. Serum levels of βHB after a moderate 10-gram dose of the compound have been measured going from 0.0 mmol to as high 1.4 mmol in non-ketogenic, 75-kilogram adult son an empty stomach. By contrast, the industry standard dose of 11 grams for the common racemic salts achieve on average a very modest rise of approximately 0.2 mmol. The present invention represents a seven-fold increase in serum levels at roughly the same dose compared to racemic salts that are currently widely available.

Serum levels increases with the present invention tend to be far higher on the same 10-gram dose if the person is already in even a very moderate level of ketosis greater than 0.2 mmol. This fact should be noted in Patent AU2014236004B2 the subjects were all at or above 0.2 mmol at 0 minutes. They were clearly in a ketogenic state. The maximum serum level of βHB achieved in the trials in “FIG. 1” were only 1.2 mmol for a net rise of only 1.0 mmol despite 18 grams of βHB salt ingested.

The present invention achieved a net rise of 2.0-2.5 mmol using a subject already in mild ketosis using a very modest dose of only 10 net grams of ketogenic compounds. See Table 1 and description below.

This is particularly true if the subject maintains a ketogenic diet while taking the supplements. Thus, whereas it may take weeks to measure an increase of blood ketones following a ketogenic diet alone, the utilization of the present invention will allow the increase of blood ketones to be measured quickly, thereby encouraging and motivating those pursuing a state of ketosis.

### BRIEF DESCRIPTION OF THE DRAWINGS

For a fuller understanding of the invention, reference should be made to the following detailed description, taken in connection with the accompanying drawings, in which:

FIG. 1 depicts a table of example blood BHB levels of 4 male subjects;

FIG. 2 is a table of data depicting blood βHB levels of the 4 male subjects of FIG. 1 after a single administration of a formulation according to embodiments of the present disclosure;

FIG. 3 is another table of data depicting blood BHB after another administration of the formulation according to embodiments of the present disclosure;

FIG. 4 is a table depicting mean blood BHB and glucose levels after a single administration of 10 grams of (D)-1,3BD in a 72 kg fasted male subject;

FIG. 5 illustrates a graph of mean blood BHB and glucose levels with respect to time after a single administration of the formulation according to embodiments of the present disclosure;

Table 1 is data depicting blood BHB levels of 4 male subjects with an average weight of 76 kg in a fasted state that received 5.5 grams of buffered (D) βHB together with 4.5 grams of (D)-1,3BD, 328 mg of Na+ in the form of NaHCO₃ and 500 mg of K+ in the form of KHCO3, at 15, 30, 45 and 60 minutes after oral administration. Again, it must be stressed that of the subjects started the trial at 0.0 mmol βHB. None of the subjects were following a ketogenic diet nor in ketosis at the time of the trial, the net rise in serum βHB on average of 1.3 mmol/10 grams of active ketogenic compound was higher than any other known ketogenic compound or formulation ever tested on a gram to gram basis. Currently, the most powerful ketogenic compound noted in academic literature is the ketone ester (D)-3-hydroxybutyl-(D)-3-hydroxybutyrate. That compound is an ester formed by reacting (D)-3-hydroxybutyrate and (D)-1,3-butanediol. That compound has been shown to produce average serum increases for βHB of only 1.0 mmol/10 grams of active ketones in a 72 kg subject. For reasons not yet understood and not expected, the non-esterified components, described in this patent, simply mixed together but not reacted produce an increase in serum levels of 30% over the ester comprised of the same acid and alcohol. That fact has significant implications in the treatment of many diseases and conditions by lowering the overall salt delivery to only what is needed to buffer the compound for oral and parenteral delivery and replace the modest amount of sodium and potassium lost to the diuretic effects of βHB. Furthermore, the ester is notoriously unpalatable despite considerable efforts to mitigate the terrible taste. The unpalatability of the ester has shown to reduce adherence to daily dosing. Many patients spit out the formulations comprised of the ester. The invention described herein however, has been described as very pleasant tasting. A single long-term patient currently using the acid/diol formulation has been able to strictly adhere to dosing over the last twelve months with no complaints.

TABLE 1
5.5 g HB + 4.5 g 1,3BD Non-Keto Subjects

| | Wt | | +15 | +30 | +45 | +60 | +90 |
|---|---|---|---|---|---|---|---|
| Name | Kg | T = 0 | Min | Min | Min | Min | Min |
| Michael | 70 | 0.0 | 0.9 | 1.3 | 1.4 | 0.9 | NA |
| Mario | 81 | 0.0 | 0.9 | 1.1 | 1.2 | 0.6 | NA |
| Steve | 72 | 0.0 | 0.7 | 1.2 | 1.4 | 0.9 | NA |
| Angel | 81 | 0.0 | 1.0 | 1.2 | 1.1 | 0.7 | NA |
| Average | 76 | 0.0 | 0.875 | 1.2 | 1.3 | 0.78 | NA |

Table 2 is data depicting blood βHB levels after a single administration of 5.5 grams of buffered (D) βHB together with 4.5 grams of (D)-1,3BD, 328 mg of Na+ in the form of NaHCO3 and 500 mg of K+ in the form of KHCO3 in a fasted 70 kg male subject who was following a strict ketogenic diet and keto adapted due at 15, 30, 45 and 60 minutes after oral administration. The net rise of 2.0 mmol/10 grams of the ketogenic formulation was the highest ever tested for any ketogenic compound.

TABLE 2
5.5 g HB + 4.5 g 1,3BD In Keto Subject

| | | | +15 | +30 | +45 | +60 | +90 |
|---|---|---|---|---|---|---|---|
| Name | Wt Kg | T + 0 | Min | Min | Min | Min | Min |
| Cam | 72 | 2.4 | 2.9 | 4.3 | 4.4 | 2.9 | 2.7 |

Table 3 is data depicting blood BHB after a single administration of 10 grams of buffered (D) βHB acid with 328 mg of Na+ in the form of NaHCO3 and 500 mg of K+ in the form of KHCO3 in a fasted 75 kg male subject and two fasted 65 kg female subjects at 15, 30, 45, 60 and 90 minutes after administration.

TABLE 3
10 g HB in Non-Keto Subjects

| | Wt. | | +15 | +30 | +45 | +60 | +90 |
|---|---|---|---|---|---|---|---|
| Name | Kg | T + 0 | Min | Min | Min | Min | Min |
| Tyler (M) | 80 | 0.0 | 0.2 | 0.3 | 0.3 | 0.2 | 0.1 |
| Kerry (F) | 69 | 0.0 | 0.2 | 0.3 | 0.4 | 0.3 | 0.2 |
| Erica (F) | 68 | 0.0 | 0.3 | 0.6 | 0.5 | 0.4 | 0.3 |
| Steve Z | 73 | 0.0 | 0.3 | 0.5 | 0.4 | 0.3 | 0.3 |
| (M) | | | | | | | |
| Average | 72.5 | 0.0 | 0.23 | 0.43 | 0.36 | 0.3 | 0.23 |

TABLE 4
depicting mean blood BHB and glucose levels after a single
administration of 10 grams of (D)-1,3BD in a 72 kg fasted male
subject. (D)-1,3-butanediol is rapidly converted into (D)-βHB in
the liver. On a gram to gram basis, it is a more powerful
ketogenic compound than the free acid (D)-βHB, approximately
90% as powerful as the previously mentioned ketone ester
but approximately 44% weaker than the combination of
and equivalent weight (D)-βHB + (D)-1,3BD

| Name | T + 0 | +15 Min | +30 Min | +45 Min | +60 Min | +90 Min |
|---|---|---|---|---|---|---|
| Steve Z | 0.0 | 0.6 | 0.9 | 0.9 | 0.5 | 0.3 |

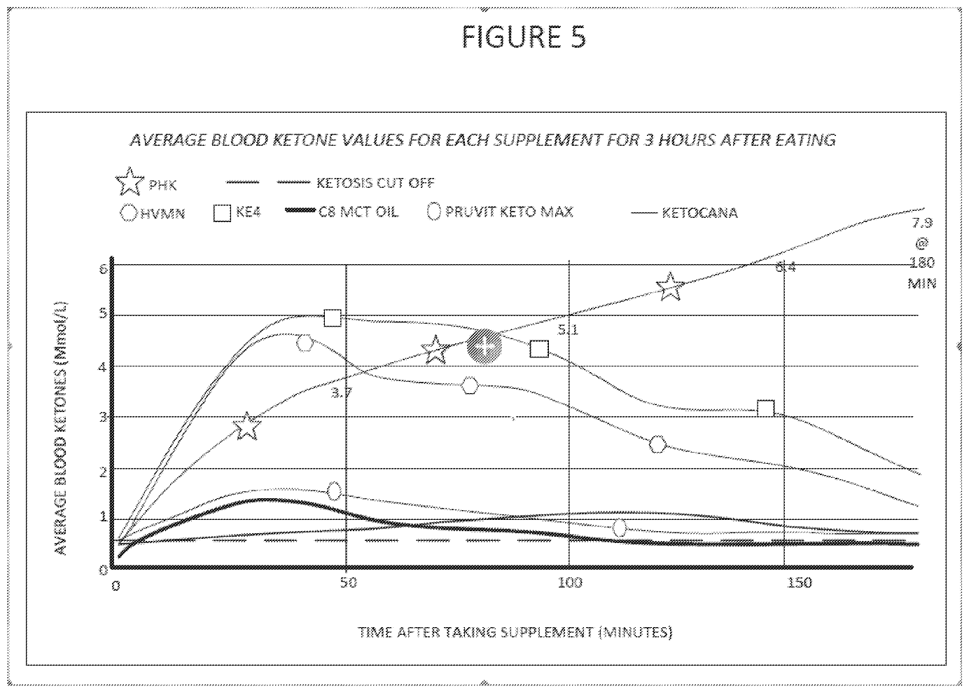

FIG. 5 Depicting blood BHB after a single administration of 33 grams of (D)-βHB and 27 grams of (D)-1,3-butanediol in a 72 kg non-fasted male subject. The total dose of 60 grams was administered 3 hours after a meal. The non-fasted administration, 3 hours post meal pushed the blood level curve to the right relative to the other high potency ester compounds by HVMN and KE4. Those esters are typically administered after an overnight fast on an empty stomach. The maximum concentration in the blood for the formulation described herein and total Area Under the Curve (AUC) was not affected by the non-fasted administration of the formulation. The high serum numbers were simply delayed. FIG. 5 also includes blood samples for 2 esters of (D)-BHB. The first was from HVMN and consisted of 50 net grams of ester (2 commercially available 30 gram bottles). The second was the ester KE4 from KetoneAid and and contained 60 net grams (2 commercially available 30 gram bottles). The choice of 60 grams of active ester was based on dosing protocols for elite athletes in the paper “Nutritional Ketosis Alters Fuel Preference and Thereby Endurance in Elite Athletes” Cell Metabolism Cox et al. 2016.

### DETAILED DESCRIPTION OF THE PREFERRED EMBODIMENT

In the following detailed description of preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

The term “about” or “approximately” as used herein refers to being within an acceptable error range for the particular value as determined by one of ordinary skill in the art, which will depend in part on how the value is measured or determined, i.e. the limitations of the measurement system, i.e. the degree of precision required for a particular purpose, such as a pharmaceutical formulation. For example, “about” can mean within 1 or more than 1 standard deviation, per the practice in the art.

Alternatively, “about” can mean a range of up to 20%, preferably up to 10%, more preferably up to 5% and more preferably still up to 1% of a given value.

Concentrations, amounts, solubilities, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include the individual values and sub-ranges within the indicated range. Thus, included in this numerical range are individual values such as 2, 3, and 4 and sub-ranges such as from 1-3, from 2-4 and from 3-5, etc. This same principle applies to ranges reciting only one numerical value.

Furthermore, such an interpretation should apply regardless of the range or the characteristics being described.

As used herein “beta-hydroxybutyrate,” also known as βHB or BHB, is a chiral carboxylic acid comprised of two enantiomers. The right-hand version can be described as either the (D) or (R) enantiomer. For example (D)-beta-hydroxybutyrate or (D)-βHB or (R)-beta-hydroxybutyrate. The left-hand enantiomer can also be described as (L) or(S) as in (L)-beta-hydroxybutyrate or(S)-beta-hydroxybutyrate. It should be noted that only the right-hand enantiomer is bioactive. All enzyme-based blood measuring devices only measure the right-hand enantiomer. The racemic compound, comprised of equivalent amounts of the (D) and (L) enantiomers have the general formula CH3CH2OHCH2COOH which may be utilized by a patient's body as a fuel source during instances of low glucose levels in the patient and is considered a ketone body. In the present invention, salt variants of beta-hydroxybutyrate are disclosed. As used herein “patient”, means members of the animal kingdom, including mammals, such as but not limited to, primates including humans, gorillas and monkeys; rodents, such as mice, fish, reptiles and birds. The patient may be any animal requiring therapy, treatment, or prophylaxis, or any animal suspected of requiring therapy, treatment, or prophylaxis. The term treatment, as used in this definition only, is intended to mean that regiment described is continued until the underlying disease is resolved, whereas therapy requires that the regiment alleviate one or more symptoms of the underlying disease. Prophylaxis means that regiment is undertaken to prevent a possible occurrence, such as where a high glucose or diabetes is identified. “Patient” and “subject” are used interchangeably herein.

“Ketosis” as used herein refers to a subject having blood ketone levels within the range of about 0.5 mmol/L and about 18 mmol/L in a subject. Ketosis may improve mitochondrial function, decrease reactive oxygen species production, reduce inflammation and increase the activity of neurotrophic factors.

“Keto-adaptation” as used herein refers to prolonged nutritional ketosis (>1 week) to achieve a sustained non-pathological “mild ketosis” or “therapeutic ketosis.”

The molecule 1,3-butanediol or 1,3BD is also a chiral molecule comprised of both (D) and (L) enantiomers. Like (D)-βHB, only (D)-1,3 is rapidly converted into (D)-βHB in the liver. Because the racemic 1,3BD is comprised of 50% (D) enantiomer, the racemic molecule, just like the racemic βHB can both be used in therapeutic applications as part of this invention. For reasons not yet know however, both and pure (D)-βHB and the pure (D)-1,3BD are unexpectedly more than twice as effective for any given weight at raising blood levels of (D)-βHB. Thus, the preferred embodiment should be comprised of the pure (D) enantiomers of both compounds or a highly enantiomerically enriched combination of both the βHB and 1,3-BD.

The term “administration” or “administering” is used to describe the process in which individual ketone esters or beta-hydroxybutyrate salts in any combination with 1,3-BD are delivered to a subject. The composition may be administered in various ways including oral, intragastric, and parenteral (referring to intravenous and intra-arterial and other appropriate parenteral routes), among others. Each of these conditions may be readily treated using other administration routes of beta-hydroxybutyrate salts in combination with the free acid, derivatives, or any combination thereof to treat a disease or condition.

Administration will often depend upon the amount of compound administered, the number of doses, and duration of treatment. In an embodiment, multiple doses of the agent are administered. The frequency of administration of the agent can vary depending on any of a variety of factors, such as timing of treatment from previous treatments, objectives of the treatment, i.e., weight loss or treatment of cancer or neurological disease, and the like. The duration of administration of the agent, e.g., the period of time over which the agent is administered, can vary, depending on any of a variety of factors, including patient response, desired effect of treatment, etc. The amount of the agent contacted (e.g., administered) can vary according to factors such as the degree of susceptibility of the individual, the age, sex, and weight of the individual, idiosyncratic responses of the individual, the dosimetry, and the like.

Detectability effective amounts of the agent of the present disclosure can also vary according to instrument and film-related factors. Optimization of such factors is well within the level of skill in the art. The “therapeutically effective amount” for purposes herein is thus determined by such considerations as are known in the art. A therapeutically effective amount of individual partially buffered beta-hydroxybutyrate in combination with 1,3-BD, derivatives, or any combination thereof is that amount necessary to provide a therapeutically effective result in vivo. The amount of partially buffered beta-hydroxybutyrate in combination with 1,3-BD, derivatives, or any combination of partially buffered beta-hydroxybutyrate in combination with 1,3-BD or derivatives thereof must be effective to achieve a response, i.e. therapeutic ketosis. In accordance with the present invention, a suitable single dose size is a dose that is capable of preventing or alleviating (reducing or eliminating) a symptom in a patient when administered one or more times over a suitable time period. One of skill in the art can readily determine appropriate single dose sizes for systemic administration based on the size of a mammal and the route of administration.

The amount of the partially buffered beta-hydroxybutyrate in combination with 1,3-BD or derivatives, such as non-toxic alcohols will depend on absorption, distribution, metabolism, and excretion rates of the partially buffered beta-hydroxybutyrate in combination with 1,3-BD or derivatives, the particular partially buffered beta-hydroxybutyrate in combination with 1,3-BD or derivatives, the method of administration, and the particular disorder being treated, as well as other factors known to those of skill in the art. The dose should be sufficient to affect a desirable response, such as a therapeutic or prophylactic response against a particular disorder or condition, taking into account the severity of the condition to be alleviated. The compounds may be administered once, or may be divided and administered over intervals of time. It is to be understood that administration may be adjusted according to individual need and professional judgment of a person administrating or supervising the administration of the compounds used in the present invention.

### Statistics

The invention presented herein details the unexpected benefit of the combination of 1,3BD with partially buffered βHB for the immediate and sustained elevation of ketone bodies when taken orally by mammals. The combination of partially buffered βHB with 1,3-BD disclosed herein produced blood ketone levels at a rate and peak level greater than what was achieved with either component alone. Unexpectedly, in later time periods, this elevation in blood ketones is sustained at a higher level than what would be anticipated based on the sum of data from the ingestion of each component separately. The combination of 1,3-BD with partially buffered βHB allows for lower dosing of the components as compared to administering the individual compounds, thereby reducing side effects and resulting in a novel blood ketone profile. In addition, the combination of 1,3-BD with partially buffered βHB allows for a reduction of overall salt load by up to 99% compared to traditional fully buffered racemic βHB salts that have been used in some therapeutic settings. Historically, the fully buffered βHB salts have never been widely adopted in therapies because the fully buffered, racemic salts were never able to safely reach therapeutic levels of (D)-βHB without a dangerous and potentially fatal rise in salt loads in humans or other mammals.

Ketones and in particular, βHB have been shown to also safely and effectively lower glucose levels. The following information was taken from US20140350105A1 “Fasting can have many health benefits; however, it is often accompanied by discomfort due to hunger and lack of energy substrate (glucose) for proper brain function and depletion of sodium and potassium. Additionally, it can be associated with deleterious loss of lean body mass. This invention reduces hunger, supplies an alternative energy substrate to the brain, βHB, also generally referred to as ketones and confers a protein sparing effect that preserves skeletal muscle mass. The following examples provide evidence for the use of supplemental ketones to elevate and sustain blood levels of BHB while maintaining low and controlled blood glucose”.

### Example 1—A 100 kg Male Subject

All procedures were done in accordance with the University of South Florida Institutional Review Board (IRB) guidelines. BHB salts and MCT oil were given to human subjects as a ketogenic food supplement and blood measurements of BHB and/or glucose were taken at predetermined time points.

To determine the time course of ketosis, the subjects were orally given the test substances of a BHB salt solution (450 mL; 4%, approximately 18 g), an MCT oil (30 ml, approximately 30 g), or a combination of the a BHB salt solution and an MCT oil. Blood concentrations of glucose and BHB were determined utilizing a commercially available glucose/ketone monitoring system (Precision Xtra® blood glucose and ketone meter) at defined time points (0, 15, 30, 80, 120, 240 and 480 minutes following ingestion of the test substances).

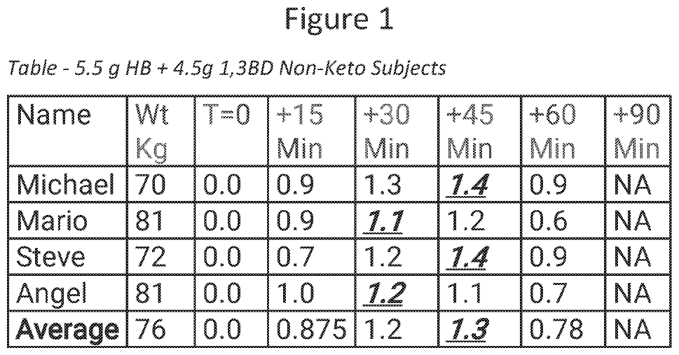

The subject was administered a BHB salt solution containing 4% Na⁺/K⁺ BHB salts in solution, an MCT oil, or a combination of the 4% Na⁺/K⁺ BHB salts and the MCT oil. At 15, 30, 60, 120, 240 and 480 minutes after administration, blood was drawn. The subject returned on days 2 and 3 for additional supplements, with blood taken as on day 1. Levels of BHB in the blood were determined as described above. Administration of the Na+/K+ BHB salt solution showed that plasma levels of BHB peaked at 30 to 60 minutes after administration, as seen in Table 1 and FIG. 1.

Table 1. Blood BHB levels (mMol) of a 100 kg male subject following a single daily of oral administration of either BHB salts (4% solution containing 1 1 grams sodium BHB and 7.1 grams potassium βHB), 30 mL of MCT oil or 1 1.1 g of βHB salts+20 mL of MCT oil at 15, 30, 60, 120, 240 and 480 minutes on three consecutive days.”

This data is not reflective of serum levels observed when subjects start at 0.0 mmol. Any level of serum. βHB at T=0 above the level of detection 0.1 will show a 50%-300% increase of βHB blood levels compared to subjects not already in ketosis who start a 0.0 mmol at T=0. The author had to know this and that is why he chose only subjects who were already in ketosis. Dominic was not being straight forward. Should this be mentioned in patent? In addition, 11 grams of sodium BHB is 9 grams net BHB. 7.1 grams of potassium BHB is 5 grams net for a total of 14 grams. BHB. The sodium was 2,000 mg which is 87% RDA. Plus 2,100 mg potassium which is 47% RDA. All that for a 1.5 mmol rise which would have actually been closer to 0.75 mmol if the subject WAS NOT ALREADY IN KETOSIS. Patients suffering heart attack, stroke, concussion will not be in ketosis when they arrive at the hospital.

Supplementation

| | | | | |
|---|---|---|---|---|
| Time | Day 1 | Day 2 | Day 3 | Mean |
| Min | mM | mM | mM | mM |

BHB salt (450 mL)

| | | | | |
|---|---|---|---|---|
| 0 | 0.2 | 0.4 | 0.1 | 0.23 |
| 15 | 0.5 | 0.8 | 0.8 | 0.70 |
| 30 | 0.8 | 0.8 | 1.2 | 0.93 |
| 60 | 1 | 0.6 | 1.2 | 0.93 |
| 120 | 1.2 | 0.3 | 0.8 | 0.77 |
| 240 | 0.4 | 0.1 | 0.3 | 0.27 |
| 480 | 0.3 | 0.2 | 0.3 | 0.27 |

MCT (30 mL)

| | | | | |
|---|---|---|---|---|
| 0 | 0.1 | 0.3 | 0.2 | 0.20 |
| 15 | 0.2 | 0.3 | 0.4 | 0.30 |
| 30 | 0.4 | 0.8 | 0.4 | 0.53 |
| 60 | 0.5 | 0.6 | 0.5 | 0.53 |
| 120 | 0.5 | 0.6 | 0.3 | 0.47 |
| 240 | 0.1 | 0.2 | 0.1 | 0.13 |
| 480 | 0.2 | 0.1 | 0.1 | 0.13 |

BHB salt (450 mL) + MCT (30 mL)

| | | | | |
|---|---|---|---|---|
| 0 | 0.1 | 0.3 | 0.2 | 0.20 |
| 15 | 0.5 | 0.7 | 0.4 | 0.53 |
| 30 | 0.7 | 0.8 | 1.0 | 0.83 |
| 60 | 1.3 | 1.2 | 1.5 | 1.33 |
| 120 | 0.9 | 1.2 | 1.2 | 1.10 |
| 240 | 0.4 | 1.0 | 0.5 | 0.63 |
| 480 | 0.4 | 0.8 | 0.3 | 0.50 |

Administration of MCT oil showed little elevation in BHB levels. Administration of BHB salts showed higher elevation in BHB levels than MCT oil alone. The combination of BHB salts showed further elevation in BHB levels than either BHB salts or MCT oils alone. In comparison, administration of Na⁺/K⁺ BHB salt solution or the MCT oil alone showed peak. BHB levels at 60 minutes, which remained fairly elevated through 120 minutes after administration, as seen in Tables 1 and 2 and FIG. 1. Further, administration the combination of Na⁺/K⁺ BHB salt solution and MCT oil increased BHB plasma levels well above those seen by BHB salts or MCT oil alone, as evidence of a synergistic effect between the combination of Na′/K′ BHB salt and MCT oil. By day 3, administration of the combination of MCT and Na⁺/K⁺ BHB salt solution resulted in elevated and sustained BHB plasma levels after the oral supplementation past the 120 minute time point.

Table 2. Mean blood SHB levels of a 100 kg male subject over 3 days following a single daily oral administration of either βHB salts (4% solution containing 1 1 grams sodium BHB and 7.1 grams potassium BHB), MCT oil or βHB salts+MCT oil at 15, 30, 60, 120, 240 and 480 minutes.

BHB Salt solution (diluted 4% BHB) MCT (1:1 ratio of C8:C 10)

### Example 2—A 70 kg Male Subject

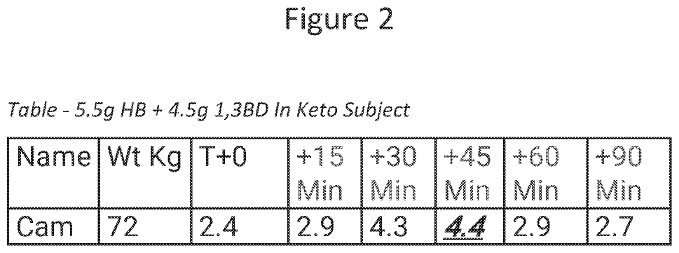

Subject (70 kg male) was instructed to fast for three days, and was given a single daily oral administration of either βHB salts (4% solution containing 1 1 grams sodium βHB and 7.1 grams potassium BHB), MCT oil or βHB salts+MCT oil at 15, 30, 60, 120, 240 and 480 minutes on 3 consecutive days. At 15, 30, 60, 120, 240 and 480 minutes after administration, blood was drawn. The subject returned on days 2 and 3 for additional supplements, with blood taken as on day 1, as in Example 1. BHB levels were determined as discussed in example 1. Administration of the combination of MCT oil and BHB salts over concurrent days resulted in elevated and sustained BHB levels after oral administration, as seen in FIG. 2. Interestingly, as supplementation progressed today 2 and day 3, elevated levels of BHB were observed sooner after supplementation and were sustained for a considerably longer time after administration, while peak βHB levels were consistent with Example 1 occurred at 60 minutes after administration, as seen in Table 3.

TABLE 3
Blood βHB levels of a 70 kg male subject following a single
daily oral administration of βHB salts (4% solution containing 1
1 grams sodium BHB and 7.1 grams potassium βHB), at 15, 30,
60, 120, 240 and 480 minutes on 3 consecutive days.

| | | | | |
|---|---|---|---|---|
| Time | Day 1 | Day 2 | Day 3 | Mean |

FASTED + BHB salts (450 mL)

| | | | | |
|---|---|---|---|---|
| 0 | 0.2 | 0.6 | 1.8 | 0.87 |
| 30 | 0.7 | 1.8 | 2.7 | 1.73 |
| 60 | 1.1 | 2.4 | 4.8 | 2.77 |
| 120 | 0.3 | 1.6 | 3.3 | 1.73 |
| 240 | 0.4 | 1.2 | 3 | 1.53 |
| 480 | 0.6 | 1.6 | 2.4 | 1.53 |

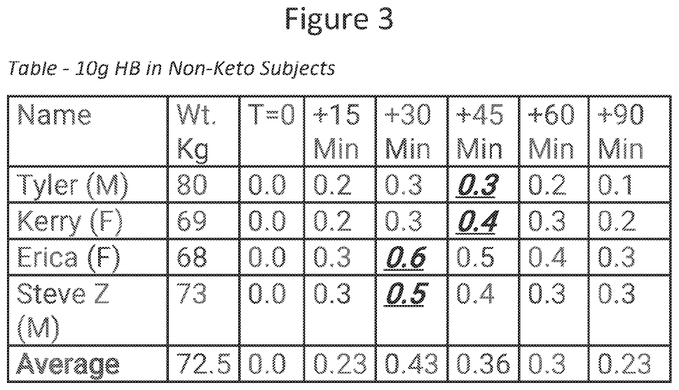

Blood glucose levels were determined as described above. Supplementation reduced plasma levels of glucose slightly, without any glucose peaks seen through the course of supplementation, as seen in FIG. 3. Supplementation showed reduced glucose throughout the time period analyzed following administration of combination of MCT and BHB salts, with a lower starting glucose level on each subsequent day, as seen in Table 4.

TABLE 4
Blood glucose levels of a 70 kg male subject following a single daily
oral administration of βHB salts (4% solution containing 1 1 grams sodium
BHB salt and 7.1 grams potassium βHB salt), or MCT oil or βHB salts +
MCT oil at 15, 30, 60, 120, 240 and 480 minutes on 3 consecutive days.

| | | | | |
|---|---|---|---|---|
| Time | Day 1 | Day 2 | Day 3 | Mean |

FASTED + BHB salts (450 mL)

| | | | | |
|---|---|---|---|---|
| 0 | 100 | 90 | 80 | 90.00 |
| 30 | 95 | 95 | 71 | 87.00 |
| 60 | 85 | 90 | 68 | 81.00 |
| 120 | 82 | 85 | 65 | 77.33 |
| 240 | 80 | 84 | 68 | 77.33 |
| 480 | 76 | 80 | 68 | 74.67 |

### Example 3˜Fasting Individuals

A combination of CT and βHB salts, seen in the examples 1 and 2, was orally administered to fasting individuals to accelerate the induction of ketosis and to study the impact of the supplement in short-term severe caloric restriction, short term fasting or intermittent fasting (e.g., alternate day fasting). The supplement provided no more than 400 calories per day and the length of time of the various restrictions and fasts were between 2 and 7 days. Rapid induction of ketosis was associated with improved compliance with caloric restriction and fasting, presumably by reducing hunger and “glucose withdrawal” symptoms {e.g., brain fog).

Caloric restriction and/or fasting resulted in substantial improvements in metabolic biomarkers related to inflammation and insulin resistance, thereby permitting individuals to lose weight and improve general health in a short period of time. Individuals with high blood glucose or type II diabetes may receive particular benefits from this supplement as it has the potential to cause a lasting improvement in insulin sensitivity and overall metabolic health (e.g., improved glucose and lipid profiles). This invention is useful for initiating and sustaining a ketogenic lifestyle by helping a subject get into ketosis quickly. The utilization of the supplement in conjunction with fasting accelerates a subject's ability to induce ketosis and is accompanied by a minimum degree of physical and mental discomfort and a minimal amount of loss of lean body mass.

### Example 4˜Adult Male Sprague-Dawley Rats

Subject rats (n=74), 275-325 grams, were randomly assigned to a control group (no supplementation) or to one of three ketone precursor groups: medium chain triglyceride (MCT) oil (MO), mineral (Na+/K+) salt of β-hydroxybutyrate (βHB) (SO), or SQ+MO 1:1 combination (SM). The ketone mineral salt was developed and synthesized by Dr. Patrick Arnold from Prototype Nutrition. Pure pharmaceutical grade MCT oil was purchased from Now Foods (Bloomingdale, IL). SM was mixed at a 1:1 ratio.

Rats were supplemented with medium chain triglyceride (MCT) oil (MO), or a mineral (Na+/K+) salt of β-hydroxybutyrate (βHB) (SO), or SQ-s-MQ 1:1 mixture (SM) and force fed a daily at a dose of 5 g/kg body weight on days 1-14, followed by a 10 g/kg dose on days 15-28 rats Supplementation was given between 10 am and 1 pm daily to eliminate variance based on regular eating patterns. Diets were not restricted for this study.

Effects of ketone supplementation on blood glucose, ketones, and lipids: Once a week, animals were fasted for 4 hours prior to intragastric gavage of the appropriate ketone supplement. The four hour food restriction was used to eliminate normal variance in blood glucose and ketone levels due to food consumption. Whole blood samples (10 μl) were acquired from the saphenous vein of the subjects for analysis of glucose and βHB utilizing the commercially available glucose and ketone monitoring system Precision Xtra™ (Abbott Laboratories, Abbott Park, IL) at time intervals of 0, 0.5, 1, 4, 8, and 12 hours after ketone precursor supplements were administered, or until βHB returned to baseline. On Day 0 (Week 0} and Day 28 (Week 4), whole blood samples (10 L) were acquired for analysis of total cholesterol, HDL, and triglycerides for a lipid panel utilizing the commercially available home cholesterol analyzer Cardio Chek™ (Polymer Technology Systems, Inc., Indianapolis, IN) at time 0. Animals were weighed once per week to maintain accurate dosage using the Mittler Toledo SB16001 scales.

Dietary Ketone Supplementation does not Affect Lipid Profile

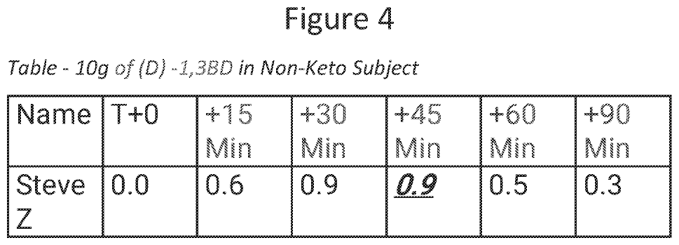

Total Cholesterol and HDL, taken at week 0 and again at week 4, showed a reduction in all samples, including the control, as seen in FIGS. 4 and 5. Analysis showed the levels in all supplements were not significantly different from control after a 4-week chronic dosage of ketone supplements. Triglyceride levels were mildly elevated at week 4 in the control, βHB/MCT sample, or βHB salt sample, with little change in levels of MCT sample, as seen in FIG. 6. However, none of the levels were significantly different from control after a 4-week chronic dosage of ketone supplements.

### Ketone Supplementation Causes Rapid and Sustained Elevation of βHB

Over the 28-day experiment, ketone supplements significantly elevated blood ketone levels without dietary restriction, as seen in FIGS. 7(A) through 9. The 5 g/kg dose for days 1-14 showed rapid elevation for the MCT oil at about 30 minutes to one hour with maximum effect at 60 minutes and sustained significant elevation until 8 hours. By weeks 2 and 3, when the dosage of MCT was increased to 10 g/kg, the SHB levels increased to a maximum level at 4 hours, followed by dropping levels of βHB, however BHB levels were still elevated in comparison to the control group, as seen in FIGS. 8(A) and (B). By week 4, the MCT oil began having an earlier effect in elevated BHB levels, with βHB levels further elevated at 30 minutes and levels spiking at 1 hour, as seen in FIG. 9. However, βHB levels at 4 and 8 hours appear to remain at about the same as BHB levels in weeks 2 and 3.

The 1-:-1 BHB salt/MCT oil combination (SM) at 5 g/kg showed significant elevation after 4 hours, but BHB levels dropped and were no longer significant at 8 hours in weeks 0 and 1. in week 2, SM was administered at 10 g/kg and started to show mild elevation earlier, which was found significant, as seen in FIG. 8(A). Further SHB levels were elevated at 8 hours beyond what was seen in weeks 0 and 1, to levels similar to MO. By week 3, the SM showed elevated βHB levels starting at 30 minutes, though less dramatic than MO, as seen in FIG. 8(B). Further, the βHB levels were elevated at 1 and 4 hours, which was not apparent at weeks 0 through 3, and the βHB levels at 8 hours were slightly depressed. That said, SHB levels were increased to significant levels from 30 minutes to 8 hours after supplementation. By week 4 of SM supplementation, βHB levels were elevated at 8 hours, similar to SHB levels seen with MO supplementation, as seen in FIG. 9.

SO supplementation did not show significant elevation at any time point. With dose escalation to 10 g/kg in groups Control, MO, SO, and SM, for days 14-28, both MO and SM were elevated at 30 min and remained significantly elevated for up to 12 hours, shifting their peak times to MO at 4 hours and SM at 8 hours. SO did not show significant elevation at any time points even with escalated dosage.

### Ketone Supplementation Causes Rapid Reduction in Blood Glucose.

SO supplementation did not show any significant difference compared to control at week 0, whereas MO and SM reduced glucose through 4 hours after supplementation, seen in FIG. 10(A) and (B). However, SO began reducing glucose by 8 hours at week 1.

By week 2 onward, with an increase in supplementation dosage to 10 g/kg, SO, MO and SM had reduced glucose levels at 30 minutes through 8 hours, with normalization to about control levels by 12 hours, as seen in FIGS. 1 1 through 12.

### The Effects of Ketone Supplementation on Organ Weight:

At the end of 4 weeks, rats were force fed at time 0 then sacrificed by CO2 between 4-8 hours, which were determined to be peak βHB level elevation. Brain, lungs, liver, kidneys, spleen and heart were harvest and weighed using AWS-100G 1 kg portable digital scale (AWS, Charleston, SC). Organs were then either flash frozen in liquid nitrogen or preserved in paraformaldehyde for future analysis.

At the end of 4 weeks, livers were harvested and weighed per subject rats, SO and SM ketone supplements significantly decreased the weight of the liver. MO significantly increased the weight of livers in the subjects, as seen in FIG. 13. No other organ showed significant differences in weight across the three ketone precursors.

### Ketone Supplementation Effects on Body Weight

Rats were administered SO, MO, or SM daily for 28 days as described above. Each week the animals were weighed. Rats that were treated with SO, MO, or SM gained significantly less weight compared to controls, as seen in FIG. 14. The control animals continued to gain weight throughout the month long month-long study, in comparison, the ketone supplement treatment groups ail gained less weight. A 2-to-3-fold reduction in weight gain was noted in the SO and SM groups. A key finding of this study is that the SM group was able to limit weight gain in an unexpected way as the amounts of βHB and MCT when combined were much lower than the amounts of those ingredients used in the SO and MO treatment groups. This effect on body weight gain is likely due to appetite suppression caused by the supplements, rather than a reduced intake of the supplement itself, as force feeding controlled for dosing.

### Example-s

In a non-limiting example, a 16-ounce drink formula containing the following ingredients (see Table 6) is consumed by an individual three times a day.

TABLE 6
List of ingredients used in preparing a ketosis
inducing drink formula Ingredient Amount

(D)-beta-hydroxybutyrate 5.5 grams
(D)-1,3-butanediol 4.5 grams
Sodium bicarbonate 342 mg with a net weight of 94 mg sodium
Potassium bicarbonate 500 mg with a net weight of 195 mg potassium
Ancillary Ingredients (not used in tests below)
Calcium beta-methyl-beta-hydroxybutyrate 1000 milligrams
Arginine alpha-ketoglutarate 1000 milligrams
Sodium R-alpha lipoic acid 100 milligrams Thiamine 20 mg
Riboflavin 20 mg
Niacin 20 mg
Pyridoxine 20 mg
Ascorbic acid 750 mg
Citric acid 1000 mg
Malic acid 1 QQ 0 mg Sodium benzoate 300 mg Potassium sorbate
300 mg
Acesulfame K 10 mg
Aspartame 30 mg Xanthan gum 1000 mg
Flavoring

The data presented herein supports the use of a unique combination of beta hydroxybutyrate and 1,3BD in order to generate a unique blood ketone profile necessary for effectively entering therapeutic ketosis. There are at least two populations that would immediately benefit from this combination formulation. First, children with epilepsy benefit from ketosis as it has been shown to reduce seizures. Second, people that are looking to lose weight, suppress the appetite, and enhance physical performance benefit from ketosis to enhance their results. In both populations, adherence to a ketogenic, carbohydrate-restricted diet as a means of generating ketosis is limited by the difficulty of generating blood ketone levels that are sufficiently elevated and prolonged. Slow entry into ketosis leads to prolonged side effects such as physical distress and mood depression. Additionally, even slight deviations from the ketogenic diet cause perturbations in blood ketone levels, thereby quickly kicking the subject out of therapeutic ketosis. The data presented herein show that the combination of BHB and MCT results in a more rapid induction of ketosis, with greater peak levels of blood ketones, and longer sustainment of ketosis, compared to either component alone, thereby overcoming the drawbacks of current approaches.

The combination of partially buffered BHB and 1,3-BD is unique in that it also avoids the complications that arise from using either substance alone. Consuming sufficient amounts of BHB salts, as opposed to the low salt, partially buffered βHB in order to quickly enter and maintain ketosis results in sodium overload and electrolyte imbalances and therefore is not practical. Consuming sufficient quantities of 1,3-BD in order to quickly enter and maintain ketosis results alcohol inebriation which although not as powerful or long-lasting as ethanol inebriation, causes inebriation nevertheless and therefore is also not practical. The βHB free acid is similar in acidity as acetic acid found in vinegar and is far too acidic to be palatable or safe to drink undiluted or used parenterally. The data presented herein shows that reduced amounts of both the partially buffered βHB and 1,3-BD can be used in combination, and not only improves tolerability, but also generates a unique blood ketone profile that has benefits not seen with the individual components when used in isolation.

In the preceding specification, all documents, acts, or information disclosed does not constitute an admission that the document, act, or information of any combination thereof was publicly available, known to the public, part of the general knowledge in the art, or was known to be relevant to solve any problem at the time of priority. It is also to be understood that the following claims are intended to cover all of the generic and specific features of the invention herein described, and ail statements of the scope of the invention which, as a matter of language, might be said to fail therebetween.

### PATENT CITATIONS (23)

U.S. Pat. No. 5,093,044A * 1988 Sep. 7 1992 Mar. 3 Kabivitrum Triglyceride nutrient for humans and animals
U.S. Pat. No. 6,323,237B1 1997 Mar. 17 2001 Nov. 27 Btg International Limited Therapeutic compositions
US20080287372A1 * 2000 May 1 2008 Nov. 20 Accera, Inc. Use of Ketogenic Compounds for Treatment of Age-Associated Memory Impairment
US20100041751A1 * 2005 Jun. 20 2010 Feb. 18 Accera, Inc. Method to Reduce Oxidative Damage and Improve Mitochondrial Efficiency
US20100197758A1 * 2007 Apr. 12 2010 Aug. 5 Andrews Matthew Ischemia/reperfusion protection compositions and methods of using
US20100298294A1 * 2008 Jan. 4 2010 Nov. 25 Isis Innovation Limited Ketone bodies and ketone body esters as blood lipid lowering agents

### FAMILY TO FAMILY CITATIONS

U.S. Pat. No. 5,654,266A * 1992 Feb. 10 1997 Aug. 5 Chen; Chung-Composition for tissues to sustain viability and biological functions in surgery and storage
CN1315473C * 1997 Mar. 17 2007 May 16 [symbol] Therapeutic composition
U.S. Pat. No. 6,316,038B1 1997 Mar. 17 2001 Nov. 13 Btg International Limited Therapeutic compositions
US20090253781A1 2002 May 24 2009 Oct. 8 Btg International Limited Therapeutic compositions
JPH1160434A 1997 Aug. 12 1999 Mar. 2 Kanebo Ltd Cosmetic for preventing skin aging AT283056T * 1998 Jul. 22 2004 Dec. 15 Metabolix Inc Food and therapeutic use of hydroxyalkanoate oligomers
JP2002524506A 1998 Sep. 15 2002 Aug. 6 [symbol] [symbol] [symbol] Therapeutic composition (ii)
TWI249401B * 1999 Apr. 14 2006 Feb. 21 Takeda Chemical Industries Ltd Agent for improving ketosis
EP2065041A1 2000 May 1 2009 Jun. 3 Accera, Inc. Use of medium chain triglycerides for the treatment and prevention of Parkinson's disease, Huntington' disease or Amyloid Lateral
U.S. Pat. No. 6,613,356B1 2000 Oct. 10 2003 Sep. 2 Victor Vlahakos Weight loss medication and method
US20050129783A1 * 2001 Apr. 19 2005 Jun. 16 Mccleary Edward L. Composition and method for treatment of neurophysiological conditions and maintenance of neurophysiological health
U.S. Pat. No. 8,158,184B2 * 2004 Mar. 8 2012 Apr. 17 Bunge Oils, Inc. Structured lipid containing compositions and methods with health and nutrition promoting characteristics GB0410266D0 * 2004 May 7 2004 Jun. 9 Ketocytonyx Inc Treatment of apoptosis GB0420856D0 2004 Sep. 20 2004 Oct. 20 Ketocytonyx Inc CNS modulators WO2008005818A1 2006 Jun. 30 2008 Jan. 10 Stepan Co Glyceride esters for the treatment of diseases associated with reduced neuronal metabolism of glucose
GB201002983D0 * 2010 Feb. 22 2010 Apr. 7 Tdeltas Ltd Nutritional composition GB201206192D0 2012 Apr. 5 2012 May 23 Tdeltas Ltd Ketone bodies and ketone body esters and for maintaining or improving muscle power output
* Cited by examiner, † Cited by third party

### NON-PATENT CITATIONS (1)

### Title

See also references of EP2976073A4 *
* Cited by examiner, † Cited by third party

### CITED BY (18)

### Publication Number Priority Date Publication Date Assignee Title

JP2017515458A * 2014 Apr. 2 2017 Jun. 15 [symbol] [symbol] [symbol] University of Southern California The treatment of autoimmune and multiple sclerosis
GB2517088B * 2013 Aug. 7 2017 Nov. 29 Tdeltas body and ketone body ester for reducing muscle breakdown
U.S. Pat. No. 10,051,880B2 2008 Aug. 21 2018 Aug. 21 Oxford University Innovation Limited Hydroxybutyrate ester and medical use thereof
WO2018187852A1 * 2017 Apr. 12 2018 Oct. 18 Cavaleri Franco Butyrate and beta-hydroxybutyrate compositions and methods of use thereof
GB2568791A * 2017 Sep. 27 2019 May 29 Tdeltas Ltd Method of treatment Family To Family Citations
U.S. Pat. No. 10,292,952B2 * 2016 Mar. 11 2019 May 21 Axcess Global Sciences, LLC Mixed salt compositions for maintaining or restoring electrolyte balance while producing elevated and sustained ketosis
WO2017165443A1 * 2016 Mar. 21 2017 Sep. 28 Csilla Ari D'Agostino Methods of improving motor function using ketone supplementation
US20190091189A1 * 2016 Mar. 21 2019 Mar. 28 Csilla Ari D'Agostino Administration of exogenous ketone to lower blood glucose
AU2017253110A1 * 2016 Apr. 19 2018 Nov. 15 Keto Patent Group, Inc. Administration of berberine metabolites
US20170296501A1 * 2016 Apr. 19 2017 Oct. 19 Keto Patent Group, Inc. Administration of butyrate, beta-hydroxybutyrate, and related compounds in humans
CA3036516A1 * 2016 Sep. 13 2018 Mar. 22 Abbott Laboratories Ketogenic nutritional compositions
AU2017347778A1 * 2016 Oct. 24 2019 May 16 University Of South Florida Delaying latency to seizure by combinations of ketone supplements
US20180177753A1 * 2016 Dec. 23 2018 Jun. 28 Neuroenergy Ventures, Inc. Glyceryl 3-hydroxybutyrates for migraine symptom management
U.S. Pat. No. 9,925,164B1 2017 Jan. 12 2018 Mar. 27 Neuroenergy Ventures, Inc. Glyceryl 3-hydroxybutyrates for traumatic brain injury
WO2018186481A1 * 2017 Apr. 6 2018 Oct. 11 [symbol] Device for monitoring ketogenic diet efficacy
CN109394745A * 2017 Aug. 17 2019 Mar. 1 [symbol] ( [symbol] ) [symbol] [symbol] A kind of composition comprising L-carnitine and beta-hydroxy-butanoic acid compound U.S. Pat. No. 10,245,242B1 2017 Nov. 22 2019 Apr. 2 Axcess Global Sciences, LLC Non-racemic beta-hydroxybutyrate compounds and compositions enriched with the R-enantiomer and methods of use
U.S. Pat. No. 10,245,243B1 2017 Dec. 19 2019 Apr. 2 Axcess Global Sciences,-racemic beta-hydroxybutyrate compounds and compositions enriched with the S-enantiomer and methods of use
* Cited by examiner, † Cited by third party, ‡ Family to family citation

### SIMILAR DOCUMENTS

### Publication Publication Date Title

AU2003266400C1 2004 Apr. 8 Leucine-enriched nutritional compositions
RU2444912C2 2012 Mar. 20 Application of nutritive compositions for diseases prevention EP1087779B1 2011 Nov. 23 Compositions for increasing energy in vivo
U.S. Pat. No. 6,031,000A 2000 Feb. 29 Composition comprising β-hydroxy-β-methylbutyric acid and at least one amino acid and methods of use
JP4699901B2 2011 Jun. 15 Adding material for diet and a body fat metabolism and the utilization functions of the combustion energy
EP1699449B1 2014 Jan. 22 Use of a fatty acid composition comprising at least one of epa and dha or any combinations thereof.
AU739876B2 2001 Oct. 25 Therapeutic and dietary compositions containing essential fatty acids and bioactive disulphides
CN1097436C 2003 Jan. 1 Medical food for diabetics
Karlic et al. 2004 Supplementation of L-carnitine in athletes: does it make sense?
Fitschen et al. 2013 Efficacy of β-hydroxy-β-methylbutyrate supplementation in elderly and clinical populations
U.S. Pat. No. 8,017,651B2 2011 Sep. 13 Compositions and methods for the treatment of HIV-associated fat maldistribution and hyperlipidemia
U.S. Pat. No. 5,919,767A 1999 Jul. 6 Use of pyruvate and anti-cortisol compounds in a method for enhancing physical endurance and athletic endurance in a mammal
US20070292493A1 2007 Dec. 20 Pharmaceutical composition and method for the transdermal delivery of calcium.KR101325374B1 2013 Nov. 8 Oral or enteral composition useful for recovery of physical functions
CN1076183C 2001 Dec. 19 The new beverage
JP2004509143A 2004 Mar. 25 Chromium complex, the treatment of diabetes by conjugated fatty acids and/or conjugated fatty alcohol, body fat reduction, improved insulin sensitivity, methods and compositions reduce hyperglycemia reduces and hypercholesterolemia
U.S. Pat. No. 6,534,480B2 2003 Mar. 18 Compositions for increasing energy in vivo
DK2381784T3 2018 Oct. 22 Nutritionally interventions for improving muscle function and strength
JP2006520335A 2006 Sep. 7 Compositions containing fatty acids and amino acids U.S. Pat. No. 7,335,651B2 2008 Feb. 26 Compositions incorporating (−)-hydroxycitric acid and related methods for promoting fat oxidation
JPH06157303A 1994 Jun. 3 Fatty acid treatment
CN1251496A 2000 Apr. 26 Nutritional supplement for promoting skeletal muscles to adapt strenuous exercise and resisting over fatigue of human body
Jeukendrup et al. 2004 Fat supplementation, health, and endurance performance ES2344017T3 2010 Aug. 16 Use of pinolenic acid for the treatment of obesity.
U.S. Pat. No. 5,550,113A 1996 Aug. 27 Blood sugar regulating composition and methods relating thereto

### PRIORITY AND RELATED APPLICATIONS CHILD APPLICATIONS (1)

### Application Priority Date Filing Date Relation Title

U.S. Ser. No. 14/455,385 2013 Mar. 192014 Aug. 8 Continuation Compositions and methods for producing elevated and sustained ketosis

### PRIORITY APPLICATIONS (4)

### Application Priority Date Filing Date Title

US201361803203P 2013 Mar. 192013 Mar. 19 US Provisional application
U.S. 61/803,203 2013 Mar. 19
US201461926664P 2014 Jan. 132014 Jan. 13 US Provisional application
U.S. 61/926,664 2014 Jan. 13

### APPLICATIONS CLAIMING PRIORITY (21)

### Application Filing Date Title

CA2902603A 2014 Mar. 19 Compositions and methods for producing elevated and sustained ketosis
NZ711433A 2014 Mar. 19 Compositions and methods for producing elevated and sustained ketosis
RU2015136190A 2014 Mar. 19 Compositions and methods for elevating and sustaining ketosis
SG11201506780RA 2014 Mar. 19 Compositions and methods for producing elevated and sustained ketosis
CN201480016818.0A 2014 Mar. 19 Compositions and methods for producing elevated and sustained ketosis
MX2015013312A 2014 Mar. 19 Compositions and methods for producing elevated and sustained ketosis.
EP14770025.6A 2014 Mar. 19 Compositions and methods for producing elevated and sustained ketosis
AU2014236004A 2014 Mar. 19 Compositions and methods for producing elevated and sustained ketosis
BR112015024186A 2014 Mar. 19 Compositions and methods for the production and maintenance of high ketosis
KR1020157025528A 2014 Mar. 19 Compositions and methods for producing elevated and sustained ketosis
JP2016504350A 2014 Mar. 19 Causing ketosis which and continues enhanced, for appetite suppression, for weight loss promoting, or compositions for treating obesity and methods
U.S. Ser. No. 14/455,385 2014 Aug. 8 Compositions and methods for producing elevated and sustained ketosis
ZA2015/06387A 2015 Sep. 1 Compositions and methods for producing elevated and sustained ketosis
PH12015501966A 2015 Sep. 4 Compositions and methods for producing elevated and sustained ketosis
IL241316A 2015 Sep. 8 Compositions and preparation thereof for producing elevated and sustained ketosis
U.S. Ser. No. 14/860,092 2015 Sep. 21 Compositions and methods for producing elevated and sustained ketosis
CR20150579A 2015 Oct. 19 Compositions and methods for producing sustained high ketosis
HK16104766.6A 2016 Apr. 26 Compositions and methods for producing elevated and sustained ketosis
U.S. Ser. No. 15/610,668 2017 Jun. 1 Compositions and methods for producing elevated and sustained ketosis
IL259502A 2018 May 21 Compositions and methods for producing elevated and sustained ketosis
AU2019200511A 2019 Jan. 25 Compositions and Methods for Producing Elevated and Sustained Ketosis

### Legal Events

### Date Code Title Description

2014 Mar. 19 WWE Wipo information: entry into national phase
Ref document number: 201480016818.0
Country of ref document: CN
2014 Nov. 12121 Ep: the epo has been informed by wipo that ep was designated in this application
Ref document number: 14770025 Country of ref document: EP Kind code of ref document: A1
2015 Aug. 25 ENP Entry into the national phase in:
Ref document number: 2902603
Country of ref document: CA
2015 Aug. 26 ENP Entry into the national phase in:
Ref document number: 2015136190
Country of ref document: RU
Kind code of ref document: A
Ref document number: 2016504350
Country of ref document: JP
Kind code of ref document: A
2015 Sep. 4 WWE Wipo information: entry into national phase
Ref document number: 12015501966
Country of ref document: PH
2015 Sep. 8 WWE Wipo information: entry into national phase
Ref document number: 241316
Country of ref document: IL
2015 Sep. 10 ENP Entry into the national phase in:
Ref document number: 2014236004
Country of ref document: AU
Date of ref document: 20140319
Kind code of ref document: A
2015 Sep. 16 ENP Entry into the national phase in: Ref document number:
20157025528 Country of ref document: KR
Kind code of ref document: A
2015 Sep. 17 WWE Wipo information: entry into national phase
Ref document number: MX/A/2015/013312
Country of ref document: MX
2015 Sep. 18 WWE Wipo information: entry into national phase
Ref document number: 002047-2015
Country of ref document: PE
2015 Sep. 21 NENP Non-entry into the national phase in:
Ref country code: DE
2015 Oct. 1 WWE Wipo information: entry into national phase
Ref document number: 2014770025
Country of ref document: EP
2015 Oct. 16 WWE Wipo information: entry into national phase
Ref document number: 15246314
Country of ref document: CO
2015 Oct. 19 WWE Wipo information: entry into national phase
Ref document number: CR2015-000579
Country of ref document: CR
2017 Jan. 17 REG Reference to national code
Ref country code: BR
Ref legal event code: B01A
Ref document number: 112015024186
Country of ref document: BR
2017 Jul. 18 ENP Entry into the national phase in: Ref document number:
112015024186 Country of ref document: BR
Kind code of ref document: A2
Effective date: 2015 Sep. 21
Data provided by IFI CLAIMS Patent Services

What is claimed is:

1. An efficient and palatable supplement for raising (D)-beta-hydroxybutyrate to ketogenic levels defined as between 0.5 mMol-10.0 mMol of (D)-beta-hydroxybutyrate in human serum, through the administration either orally or parenterally of between 10-100 grams per 75 Kg of body weight of the combination of (D)-beta-hydroxybutyrate and (D)-1,3-butanediol.

2. The method of claim one, for every 10 grams administered is comprised of a range of 1.0-9.5 grams of (D)-beta-hydroxybutyrate 0.5-9.0 grams of (D)-1,3-butanediol (active ingredients) for every 10 grams ingested, wherein the preferred ratio for every 10 grams ingested is
5.5 grams of (D) beta-hydroxybutyrate and
4.5 grams of (D) 1,3-butanediol.

3. The method of claim one wherein the beta-hydroxybutyrate or 1,3-butanediol used is pure and of the biologically active chiral form, or if a racemic mixture is used, it is substantially enriched in the active form of the combination of both active ingredients.

4. The method of claim one wherein beta-hydroxybutyrate is partially buffered with bases to form salts to increase the pH of the formulation for oral and parenteral administration, to counteract the loss of cations due to ketone induced diuresis and to further improve the taste, including but not limited to the use of bases including carbonates such as NaHCO3, KHCO3, CaCO3 and MgCO3.

5. The method of claim one used to raise serum blood levels of beta-hydroxybutyrate in individuals on an unrestricted diet and not already in a state of ketosis, to ketogenic levels, averaging 1.1 mMol/L at the lowest dose of 10 g/75 Kg of body weight to as much as 10.0 mMol/L at the highest dose of 100 g of the combination of active ingredients per 75 Kg of body weight.

6. The method of claim one wherein the supplement is taken at multiple times throughout the day, up to three times a day.

7. The method of claim one wherein the supplement is delivered orally, preferably in the form of a ready to drink formula, but also in any of the of the following alternative formats: a spray dried powdered mixture using a solid substrate, in hard or soft gelatin caps, as a concentrated gel or part of any food stuffs such as bars and chews.

8. The method of claim one wherein the supplement is further enhanced by the addition of additional ketogenic compounds, including but not limited to glycerol, butyric acid, pyruvic acid, acetoacetate, and their related derivatives or metabolic precursors.

9. The method of claim one wherein the supplement is combined with other nutritional aides, including but not limited to amino acids, amino acid metabolites, vitamins, minerals, coconut milk powder, electrolytes, NADH, tetrahydrobiopeterin, alpha-ketoglutaric acid, alpha lipoic acid, nutritional co-factors, calcium beta-methyl-beta-hydroxybutyrate, arginine alpha-ketoglutarate, sodium R-alpha lipoic acid, thiamine, riboflavin, niacin, pyridoxine, ascorbic acid, citric acid, malic acid, sodium benzoate, potassium sorbate, acesulfame K, aspartame, xanthan gum, and combinations thereof.

10. A supplement useful to superinduce serum levels of beta-hydroxybutyrate in individuals already in a state of nutritional ketosis, consumed between 10-100 g per 75 Kg of body weight, and comprised of the following per each 10 grams ingested is comprised of a range of 1.0-9.5 grams of (D)-beta-hydroxybutyrate 0.5-9.0 grams of (D)-1,3-butanediol (active ingredients) for every 10 grams ingested. The preferred ratio for every 10 grams ingested is 5.5 grams of (D) beta-hydroxybutyrate and grams of (D) 1,3-butanediol.

11. The use of glycerol in humans to potentiate the ketogenic effects of exogenous (D) beta-hydroxybutyrate and other similar exogenous ketones such as (D) 1,3-butanediol, (R)-3-hydroxybutyl (R)-3-hydroxybutyrate, butyric acid and medium chain triglycerides, or any combination of these ketogenic compounds.

12. The composition of claim 1 to suppress appetite and encourage weight loss in humans.

13. The composition of claim 1 to be used as a medicament.

14. A method of treating heart attack, stroke, traumatic brain and other forms of ischemia injury by providing fuel starved cells a source of fuel through the passive diffusion of (D)-beta-hydroxybutyrate in tissue wherein the active transport of glucose by insulin has been impaired and/or pyruvate dehydrogenase activity has been impaired through oral or parenteral administration.

15. A method of reducing inflammation and vascular epithelium porosity via oral or parenteral administration.

16. A method of treating the symptoms of neurodegenerative diseases such as Alzheimer's Disease, Parkinson's Disease and ALS Disease by providing fuel starved cells a source of fuel through the passive diffusion of (D)-beta-hydroxybutyrate in tissue wherein the active transport of glucose by insulin has been impaired and/or pyruvate dehydrogenase activity has been impaired through oral or parenteral administration.

17. A method of improving organ transplant outcomes by directly reducing oxidative stress to be administered to the donor, in mechanical perfusion fluid and in the recipient during and after surgery.

18. A method of reducing the malaise and cravings of acute and post acute alcohol and benzodiazepene withdrawal via safely elevating serum (D)-beta-hydroxybutyrate levels between 1.0-6.0 mMol in order to mitigate impaired neural glucose metabolism described in the brains of alcoholics and benzodiazepene addicts.

19. The method of claim 18 further comprising use of ascorbic acid in combination with (D)-beta-hydroxybutyrate and (D)-1,3-butanediol to increase the oral availability of ascorbic acid and the active transport into immune cells via heightened insulin sensitivity associated with an increase in serum (D)-beta-hydroxybutyrate.
